(19) United States
(12) Patent Application Publication
(10) Pub. No.: US 2018/0376514 A1
(43) Pub. Date: Dec. 27, 2018

(54) METHODS OF UPLINK BROADCAST, TERMINAL DEVICE, AND NETWORK NODE

(71) Applicant: Alcatel Lucent, Nozay (FR)

(72) Inventor: Yonggang Wang, Shanghai (CN)

(73) Assignee: Alcatel Lucent, Nozay (FR)

(21) Appl. No.: 16/064,689

(22) PCT Filed: Nov. 30, 2016
(86) PCT No.: PCT/IB2016/001937

§ 371 Date: Jun. 21, 2018

(30) Foreign Application Priority Data
Dec. 21, 2015 (CN) 201510969237.5

(51) Int. Cl. H04W 74/08; H04W 72/12; H04W 76/11

(52) U.S. Cl. CPC H04W 74/0841; H04W 72/1294; H04W 72/005; H04W 76/11; H04W 72/1284

(57) ABSTRACT

Embodiments of the present disclosure relate to methods of uplink broadcast, a terminal device, and a network node. There is provided a method of uplink broadcast. The method comprises: initiating uplink broadcast on an uplink channel; and receiving, from at least one network node, a response to the uplink broadcast. There is also disclosed a corresponding terminal device and a network node.

### TECHNICAL FIELD

Embodiments of the present disclosure generally relate to communication technologies, and more specifically relate to methods of uplink broadcast, a terminal device, and a network node.

### BACKGROUND

In cellular communication networks such as global mobile communication systems (GSM)/wideband code division multiple access (WCDMA)/long-term evolution (LTE) of the 3rd generation partnership project (3GPP), a terminal device typically camps on a cell served by a base station. If the terminal device is to transmit data, the terminal device first initiates a random access procedure towards the base station serving the terminal device.

For example, the terminal device may send a random access request, such as a random access preamble, to the base station. Upon receiving the random access preamble sent by the terminal device, the base station returns to the terminal device a random access response which includes a grant for subsequent layer 2 (L2)/layer 3 (L3) messages of the terminal device. The terminal device may send the L2/L3 messages based on the grant and then complete the random access, so as to perform subsequent data transmission.

A typical random access procedure is a contention-based random access procedure. During this random access procedure, all terminal devices share a set of random access preambles to initiate random access requests. For example, if a terminal device is to initiate the random access procedure, the terminal device first selects a preamble from the set of random access preambles, and then sends the selected preamble to the base station on a random access channel (RACH), where the sent random access preamble is scrambled with an identifier of the base station, such as a cell identity (ID).

During the contention-based random access procedure, any terminal device may send the random access request to the base station with the selected random access preamble when necessary. Thus, if a plurality of terminal devices simultaneously select the same random access preamble to send the random access request to the same base station, conflicts will occur at the base station side. This will cause the base station unable to receive the random access preambles sent by the terminal devices and then unable to make corresponding responses, thereby resulting in access failures of the terminal devices.

In current standardization of the fifth generation (5G) cellular communication network, for small data transmission of machine-to-machine communications, a contention-based data transmission scheme is proposed. For example, when any machine terminal device, which is deployed in a network, is to transmit small data, the machine terminal device may directly send a data request message or directly transmit the data to the base station. Such a contention-based data transmission scheme will also encounter the above conflict problem.

In addition, a similar conflict issue may also exist in a computer communication network. For example, in a wireless fidelity (Wi-Fi) communication network of the Institute of Electrical and Electronic Engineers (IEEE), the terminal device to perform data transmission will directly transmit data to an access point device on which the terminal device camps. When a plurality of terminal devices concurrently transmit data to the same access point device, the conflict will occur.

### SUMMARY

Generally, embodiments of the present disclosure provide methods of uplink (UL) broadcast, a terminal device, and a network node.

In a first aspect, embodiments of the present disclosure provide a method of uplink broadcast, comprising: initiating uplink broadcast on an uplink channel; and receiving, from at least one network node, a response to the uplink broadcast.

In a second aspect, embodiments of the present disclosure provide a method of uplink broadcast, comprising: receiving uplink broadcast from a terminal device on an uplink channel; and in response to the reception of the uplink broadcast, sending a response to the uplink broadcast to the terminal device.

In a third aspect, embodiments of the present disclosure provide a terminal device, comprising: a first transmitter configured to initiate uplink broadcast on an uplink channel; and a first receiver configured to receive, from at least one network node, a response to the uplink broadcast.

In a fourth aspect, embodiments of the present disclosure provide a network node, comprising: a second receiver configured to receive uplink broadcast from a terminal device on an uplink channel; and a second transmitter configured to, in response to the reception of the uplink broadcast, send a response to the uplink broadcast to the terminal device.

Through the following description, it will be understood that according to embodiments of the present disclosure, the terminal device performs the uplink broadcast on the uplink channel. In this way, all network nodes having a coverage area that can cover the terminal device may detect the UL transmission, and thereby the possibility of conflicts of uplink transmission of terminal devices may be significantly reduced at the network nodes.

### BRIEF DESCRIPTION OF THE DRAWINGS

FIG. 1 illustrates a communication network in which the embodiments of the present disclosure may be implemented;

FIG. 2 illustrates a flow diagram of a method of UL broadcast according to one embodiment of the present disclosure;

FIG. 3 illustrates a flow diagram of a method of UL broadcast according to another embodiment of the present disclosure;

FIG. 4 illustrates a flow diagram of a method of receiving UL broadcast according to one embodiment of the present disclosure;

FIG. 5 illustrates an example flow of a random access method of a broadcast type on a random access channel according to one embodiment of the present disclosure;

FIG. 6 illustrates an example flow of a method of sending a data transmission request or transmitting data on a UL broadcast channel according to one embodiment of the present disclosure;

FIG. 7 illustrates a block diagram of a terminal device according to one embodiment of the present disclosure; and

FIG. 8 illustrates a block diagram of a network node according to one embodiment of the present disclosure.

### DETAILED DESCRIPTION

Now, the principles of the present disclosure will be described with reference to a plurality of example embodiments. It is to be understood that these embodiments are only for enabling those skilled in the art to better understand and further implement the present disclosure, without limiting the scope of the present disclosure in any manner.

As used herein, the term “network node” may be a cellular base station such as a node B (NodeB or NB), an evolved NodeB (eNodeB or eNB), or a low power node such as a pico, a femto, and the like, and a wireless access point device such as a wireless router.

As used herein, the term “terminal device” refers to any terminal device capable of communicating with the network node. By way of example, the terminal device may include a mobile terminal (MT), a subscriber station (SS), a portable subscriber station (PSS), a mobile station (MS), an access terminal (AT), a smart metering device, a portable computer device, and the like.

As used herein, the term “include” and its variants are open inclusion which means “including, but not limited to.” The term “based on” means “at least partially based on.” The term “one embodiment” represents “at least one embodiment”; the term “another embodiment” represents “at least one further embodiment.” Relevant definitions of other terms will be provided in the following description.

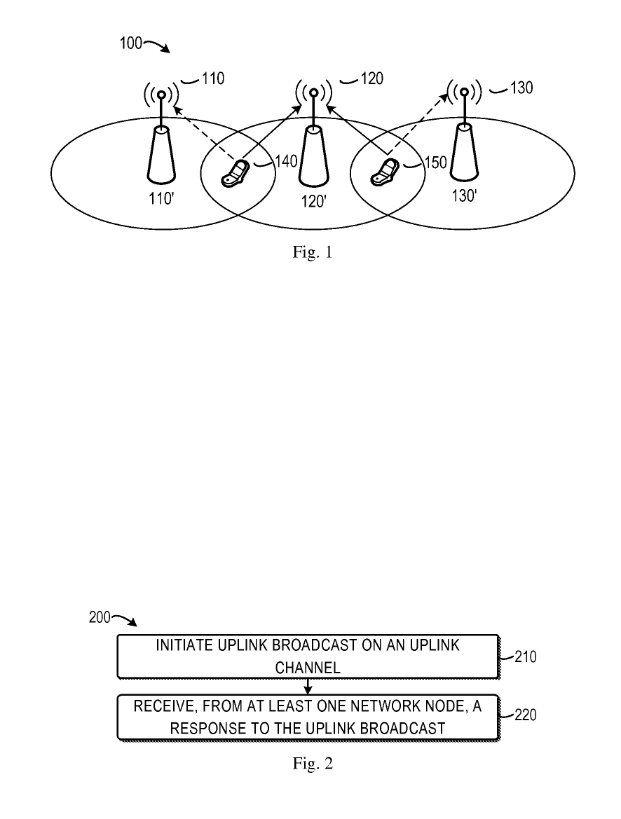

FIG. 1 illustrates a communication network 100 in which the embodiments of the present disclosure may be implemented. The communication network 100 as shown in FIG. 1 may include network nodes 110, 120, and 130 and terminal devices 140 and 150. Coverage areas of the network nodes 110, 120, and 130 are areas 110′, 120′, and 130′, respectively. The terminal devices 140 and 150 are currently located in the area 120′ and served by the network node 120.

As shown, in addition to the area 120′, the terminal device 140 is also located within the coverage area 110′ of the network node 110, and the terminal device 150 is also located within the coverage area 130′ of the network node 130. It is to be understood that the numbers of network nodes and terminal devices in FIG. 1 are only for the purpose of illustration, without suggesting any limitation. In the communication network 100, there may be any suitable number of base stations or terminal devices.

The communication between the network nodes 110, 120, and 130 and the terminal devices 140 and 150 may be implemented according to any suitable communication protocol, including, but not limited to, the first generation (1G), the second generation (2G), the third generation (3G), and the fourth generation (4G) communication protocols, the fifth generation (5G) cellular communication protocol, a wireless local area network protocol such as IEEE 802.11x, and/or any other protocols currently known or future developed.

The network nodes 110, 120 and 130 and the terminal devices 140 and 150 may use any suitable wireless communication technologies, including, but not limited to, code division multiple access (CDMA), frequency division multiple access (FDMA), time division multiple access (TDMA), frequency division duplexing (FDD), time division duplexing (TDD), multi-input multi-output (MIMO), orthogonal frequency division multiple access (OFDM), Wireless Fidelity (Wi-Fi), global microwave access interoperability (WiMAX), and/or any other technologies currently known or future developed.

In the communication network 100 of FIG. 1, when the terminal devices 140 and 150 simultaneously initiate UL transmission to the network node 120 in a contention-based manner on an uplink (UL) channel which may be shared by both of the terminal devices, the conflicts may occur. In the context of the present disclosure, “contention-based manner” refers to a transmission manner in which any terminal device, when necessary, may perform UL transmission on the corresponding channel. The channel may be any suitable channel that may be shared by a plurality of terminal devices based on contention. Accordingly, the UL transmission initiated by the terminal device on the channel may be any suitable UL transmission.

As an example, the channel may be RACH, and the UL transmission performed by the terminal device may be the transmission of a random access request. In this example, when initiating a random access process, as described above, the terminal device 140 first randomly selects a random access preamble and then sends the selected random access preamble to the network node 110. The random access preamble sent by the terminal device 140 may be scrambled using a cell ID related to the network node 110. Thereby, the network node 110 may receive, based on the cell ID, the random access request sent to the network node 110.

If the terminal device 150 selects the same random access preamble to initiate a random access process to the network node 110 at this point, then the random access preambles from the two terminal devices 140 and 150 will incur conflicts at the network node 110. Accordingly, the network node 110 may not correctly decode the random access preamble from any of the terminal devices 140 and 150, and then may not respond to the access requests from the terminal devices 140 and 150. As a result, both random access processes of the terminal devices 140 and 150 may be failed.

FIG. 2 illustrates a flow diagram of a method 200 of UL broadcast according to one embodiment of the present disclosure. It is to be understood that the method 200 may be implemented by the terminal devices 140 and 150 in the communication network 100 shown in FIG. 1. For the purpose of discussion, the method 200 will be illustrated from the angle of the terminal device 140.

As shown, the method 200 starts at step 210 where the terminal device 140 initiates UL broadcast on a UL channel. In one embodiment, the UL channel may be shared by a plurality of terminal devices based on contention. In other words, individual terminal devices may occupy the channel to perform the respective UL transmission at any time when necessary. It is to be understood that sharing of the UL channel between the plurality of terminal devices based on contention is only illustrative but not limitative. As an alternative example, a dedicated UL channel may be allocated to the terminal device for the UL broadcast. The scope of the present disclosure is not limited in this regards.

According to embodiments of the present disclosure, the UL broadcast may be implemented as any suitable UL transmission in the broadcast manner, for example, including, but not limited to, the transmission of a random access request, the transmission of a data transmission request, or the transmission of data.

According to embodiments of the present disclosure, the UL broadcast refers to UL broadcast transmission from a terminal device to a plurality of network nodes in a point-to-multipoint manner. The terminal device 140 may implement this broadcast in any suitable approach. In one embodiment, the terminal device 140 may not include an identifier of a network node in UL transmission, such that all network nodes with coverage areas covering the terminal device may detect the UL transmission from the terminal device 140.

For example, when the terminal device 140 is to send a random access request on the RACH, the terminal device 140 randomly selects a random access preamble from a predetermined set of random access preambles, and then sends the selected random access preamble on time and frequency resources configured for the RACH. Different from conventional approaches, the random access preamble is not scrambled using an identifier of a network node. In this way, in the communication network 100 as illustrated in FIG. 1, in addition to the network node 120 currently serving the terminal device 140, the network node 110 with the coverage area covering the terminal device 140 may also receive the random access preamble.

In addition to the UL broadcast based on the existing channel, as another example, a UL broadcast channel may be dedicatedly allocated to the terminal device for use in the UL broadcast. For example, during a network deployment phase, specific time and frequency resources may be pre-configured for the UL broadcast channel. Alternatively, it is also possible that the time and frequency resources, as well as channel scrambling codes, are dynamically configured by the network node for the UL broadcast channel as needed, and then information for indicating the configured UL broadcast channel is notified to other network nodes and the terminal device in the network. After the UL broadcast channel is allocated, the terminal device may perform the UL broadcast on the UL broadcast channel, for example, without carrying the identifier of the network node.

It is to be understood that such UL broadcast without carrying an identifier of a network node is only illustrative but not limitative. The present disclosure may also implement the UL broadcast in other ways. For example, the terminal device 140 may include the identifiers of a plurality of surrounding network nodes (for example, the network nodes 110, 120), such that the nearby network nodes 110 and 120 may both decode the UL transmission. The terminal device 140 may obtain the identifiers of these network nodes 110 and 120 in any suitable approach. For example, the terminal device 140 may obtain the identifiers through network searching.

Next, the method 200 proceeds to step 220 where the terminal device 140 receives, from at least one network node, a response to the UL broadcast initiated at step 210. As described above, not only the network node 120 that currently serves the terminal device 140 but also a further network node 110 whose coverage area 110′ can cover the terminal device 140 may also receive the UL broadcast. In this way, the possibility of conflicts of the UL transmission from the terminal devices will be significantly reduced at the network nodes. This is because the possibility of the simultaneous conflicts of the UL transmission at the plurality of network nodes will be much lower than the possibility of the conflicts at one network node.

FIG. 3 illustrates a flow diagram of a method 300 of UL broadcast according to another embodiment of the present disclosure. It is to be understood that the method 300 is subsequent to method 200. Hereafter, the method 300 shown in FIG. 3 will be described in conjunction with FIG. 2.

In this example, the terminal device 140 receives responses from the plurality of network nodes at step 220, and each of the responses includes a grant of subsequent UL transmission for the terminal device 140. According to embodiments of the present disclosure, the subsequent UL transmission may be any suitable UL transmission associated with the initial UL transmission. For example, if the terminal device 140 initially sends a random access request at step 210, the subsequent UL transmission may be the transmission of a L2/L3 message. As an alternative example, if the terminal device 140 initially sends a data transmission request, the subsequent UL transmission may be the transmission of data. As another alternative example, if a part of data to be transmitted is initially transmitted by the terminal device 140, the subsequent transmission may be another part of the data to be transmitted.

It is to be understood that subsequent transmission performed by the terminal device 140 is only illustrative but not limitative. In some cases, there may be no subsequent UL transmission of the terminal device 140, and the method 200 ends after the terminal device 140 receives a response from a network node. For example, if the terminal device 140 transmits all of the data to be transmitted on the UL channel in a broadcast manner at step 210 and receives an acknowledgement response from the network node at step 220, then the UL data transmission of the terminal device 140 is completed, and the method 200 ends.

As described above, the terminal device 140 initiates a UL transmission to plurality of network nodes in the broadcast manner at step 210. Accordingly, there may be a plurality of network nodes 110 and 120 that receive the UL broadcast from the terminal device 140 and grants the subsequent UL transmission of the terminal device 140. Accordingly, the terminal device 140 will receive the grants from a plurality of network nodes, for example, the network nodes 110 and 120.

As shown in FIG. 3, the method 300 starts at step 310 where in response to the reception of grants for the subsequent UL transmission from the plurality of network nodes at step 220, the terminal device 140 selects a network node to communicate from the plurality of network nodes. Next, at step 320, the terminal device 140 performs the subsequent UL transmission to the selected network node.

According to embodiments of the present disclosure, the terminal device 140 may perform the selection of the network node according to any suitable rule. In one embodiment, a network node to communicate may be selected based on signal qualities of the network nodes. For example, the terminal device 140 may select a network node with a good signal quality to initiate the subsequent communication. Considering communication efficiency, in another embodiment, the terminal device 140 may preferably select a network node, which currently has established a connection with the terminal device 140, to initiate the subsequent communication. It is to be understood that other suitable factors may be considered in selecting a network node. Alternatively or additionally, the selection may be made based on any combination of the factors in consideration. The scope of the present disclosure is not limited in this regards.

In order to save UL resources, in another embodiment, the terminal device 140 may select all of the network nodes having sent the grants to the terminal device 140 for communication. In this example, the terminal device 140 performs the subsequent UL transmission to the plurality of network nodes in the broadcast manner at step 320.

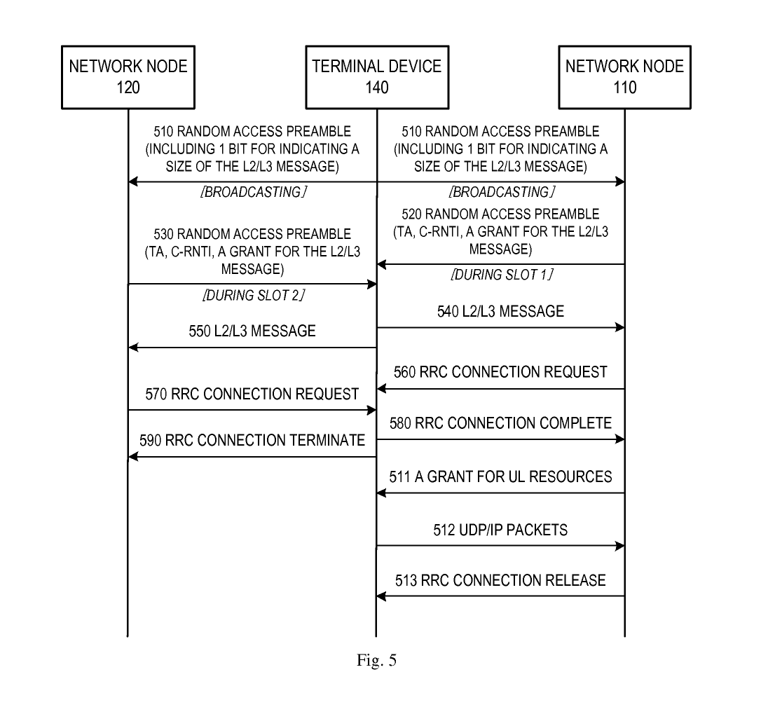

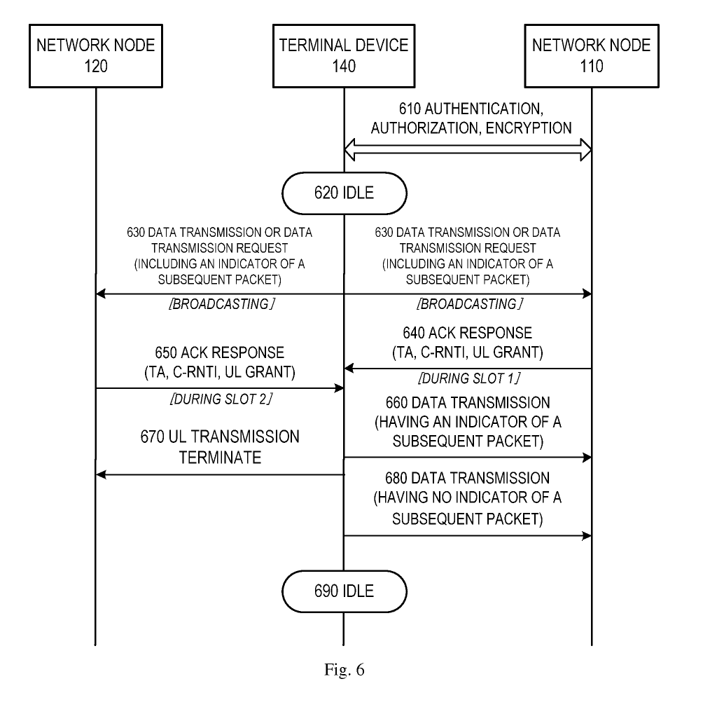

When the terminal device 140 selects one or some network nodes to perform the subsequent UL transmission, in one embodiment, the method 300 may also comprise step 330 where the terminal device 140 sends a UL transmission terminate message to an unselected network node. The UL transmission terminate message may be any suitable message for informing the corresponding network node of UL transmission termination. The message may be pre-configured by a system and be implemented in any suitable form. By way of example, the UL transmission terminate message may be implemented in radio resource control (RRC) signaling. Detailed example flows of the UL broadcast from the terminal device to the network node according to embodiments of the present disclosure will be described in the following paragraphs with reference to FIGS. 5 and 6.

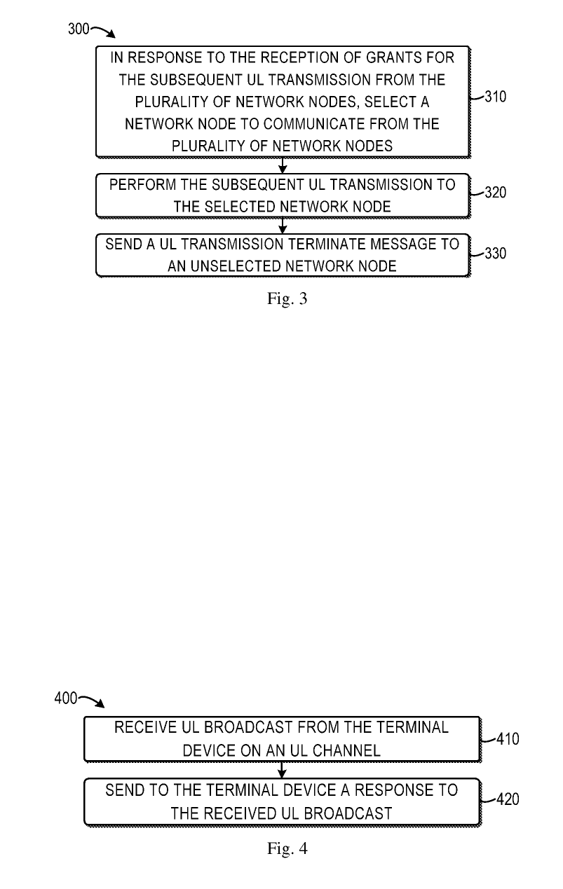

FIG. 4 illustrates a flow diagram of a method 400 of receiving UL broadcast according to one embodiment of the present disclosure. It is to be understood that the method 400 may be implemented by the network nodes 110, 120, and 130 in the communication network 100 shown in FIG. 1. For the purpose of discussion, the method 400 will be illustrated from the perspective of the network node 110.

As shown, the method 400 starts from step 410 where the network node 110 receives UL broadcast from the terminal device 110 on an UL channel. As described above, in one embodiment, the UL channel may be shared by a plurality of terminal devices based on contention. In other words, the individual terminal devices may occupy the channel to perform the respective UL transmission at any time when necessary. The UL transmission performed in the broadcast manner may be any suitable UL transmission, for example, including, but not limited to, the transmission of the random access request, the transmission of the data transmission request, or the transmission of the data.

As described above, the UL broadcast refers to the UL transmission performed by the terminal device to a plurality of network nodes in a point-to-multipoint manner. In one embodiment, an identifier of a network node may not be included in (or excluded from) the UL transmission of the terminal device 140. Accordingly, the network node 110 may detect the UL transmission including no identifier of any network node. In another embodiment, the UL transmission from the terminal device 140 may include the identifiers of a plurality of network nodes. When the identifier of the network node 110 is included, the network node 110 may detect the UL transmission.

Next, the method 400 proceeds to step 420 where the network node 110 sends to the terminal device 140 a response to the received UL broadcast. According to embodiments of the present disclosure, the response sent by the network node 110 to the terminal device 140 may include the identifier of the terminal device 140 such that the terminal device 140 can detect the response for itself.

As described above, because the UL transmission of the terminal device is performed in the broadcast manner, all network nodes with coverage areas covering the terminal device may detect the UL transmission. In this way, the possibility of conflicts of the UL transmission of the terminal devices will be significantly reduced at the network nodes.

If the terminal device 140 also has the subsequent UL transmission, in one embodiment, the response sent by the network node 110 to the terminal device 140 at step 420 may also include a grant for the subsequent UL transmission. As described above, the subsequent UL transmission may be any suitable UL transmission associated with the initial UL transmission.

As described above, the initial UL transmission of the terminal device 140 is performed in the broadcast manner. Accordingly, it is possible that a plurality of network nodes detect the UL transmission and grant the subsequent UL transmission. In this case, when the terminal device 140 receives the grants from the plurality of network nodes, the terminal device 140 may select one or more of the network nodes for the subsequent UL transmission. If the network node 110 is not selected by the terminal device 140 for subsequent communication, in one embodiment, the network node 110 may receive a UL transmission terminate message from the terminal device 140. As described above, the UL transmission terminate message may be any suitable message that informs the corresponding network node of the UL transmission termination.

It is to be understood that relevant steps or features described in discussing the method performed at the terminal device side with reference to FIGS. 2 and 3 are also applicable to the method at the network node side. Therefore, details thereof will be omitted here. Specific example flows where the terminal device performs UL broadcast to the network node according to some embodiments of the present disclosure will be described below with reference to FIGS. 5 and 6.

FIG. 5 illustrates an example flow of a method 500 of a random access of a broadcast type on the RACH channel according to one embodiment of the present disclosure. It is to be understood that the method 500 may be implemented in a communication network 100 shown in FIG. 1. For the purpose of discussion, the method 500 will be described with reference to FIG. 1.

As shown, at step 510 in the method 500, the terminal device 140 sends a random access preamble on the RACH channel in the broadcast manner. In this example, the terminal device 140 implements the transmission of a random access request of a broadcast type by not scrambling the random access preamble using an identifier of a network work. As described above, the random access preamble may be randomly selected by the terminal device 140 from a predetermined set of random access codes. The predetermined set of random access codes is known to the individual network nodes in the communication network 100, and the RACH channels of the individual network nodes occupy the same time and frequency resources. In this case, when the terminal device sends the selected random access preamble in the broadcast manner, all network nodes with the coverage area covering the terminal device may receive the random access preamble.

In the communication network 100 as shown in FIG. 1, the coverage areas 110′ and 120′ of the network nodes 110 and 120 can cover the terminal device 140. Accordingly, both of the network nodes 110 and 120 may receive the random access preamble sent by the terminal device 140 in the broadcast manner. In this example, the preambles sent by the terminal device 140 have no conflicts at the network nodes 110 and 120. Accordingly, both of the network nodes 110 and 120 correctly decode the preamble, and, then, the network node 120 in timeslot 1 at step 520 and the network node 110 in timeslot 2 at step 530 respond to the terminal device 140, for example, by feeding back a random access response to the terminal device 140.

In the example shown in FIG. 5, the terminal device has further subsequent L2/L3 messages to be sent after the random access preamble. Therefore, the terminal device 140 inserts a 1-bit indication for indicating a size of the L2/L3 message into the random access preamble that is broadcast at step 510. Accordingly, the random access responses sent by the network nodes 110 and 120 include UL grants for the subsequent L2/L3 message of the terminal device 140. In addition, the random access response may also include, among other information, timing alignment (TA), cell radio network temporary identifiers (C-RNTIs), and like.

After receiving the grants from the network nodes 110 and 120, in order to further reduce the possibility of the conflicts, the terminal device 140 sends the L2/L3 messages to both of the network nodes 110 and 120 at steps 540 and 550. The L2/L3 message may be sent to the network nodes 110 and 120 in any suitable manner. For example, the terminal device 140 may broadcast the message by not including the identifier of the network terminal in the L2/L3 message. Alternatively, the terminal device 140 may also send the message to the network nodes 110 and 120 by including the identifiers of the network nodes 110 and 120 in the L2/L3 message.

In this example, the L2/L3 messages sent by the terminal device 140 have no conflict at the network nodes 110 and 120, and, therefore, the terminal device 110 receives RRC connection requests from both of the network nodes 110 and 120 at steps 560 and 570. In this case, the terminal device 140 selects, from the network nodes, a network node for establishing a RRC connection. As described above, the terminal device 140 may perform the selection of the network node based on any suitable factor. For example, the terminal device 140 may select a network node for subsequent communication according to the signal qualities of the network nodes, whether of establishing connections to the network nodes, other suitable factors, or any combination thereof.

In this example, the terminal device 140 selects a network node 110 with a better signal quality for subsequent communication. Next, at step 580, the terminal device 140 sends a RRC connection setup complete message to the network node 110. In this example, the terminal device 140 also sends a RRC connection terminate message to the network node 120 at step 590 so as to inform the network node 120 of the termination of the subsequent transmission. The RRC connection terminate message is an example of the above-described UL transmission terminate message. As described above, according to embodiments of the present disclosure, the RRC connection terminate message may be pre-configured by the system and implemented in any suitable form. For example, the RRC connection terminate message may be implemented in the RRC signaling.

Then, at step 511, the network node 110 sends a grant of UL resources to the terminal device 140, and the terminal device 140 sends a User Datagram Protocol/Internet Protocol (IP) packet to the network node 110 using the UL resources. Then, the network node 110 sends a RRC connection release to the terminal device 140 at step 513.

FIG. 6 illustrates an example flow of a method 600 of sending a data transmission request or transmitting data on a UL broadcast channel according to one embodiment of the present disclosure. It is to be understood that the method 600 may also be implemented in the communication network 100 shown in FIG. 1. For the purpose of discussion, the method 600 will also be described with reference to FIG. 1.

As shown, at step 610 of the method 600, the terminal device 140 exchanges messages with the network node 120 providing the service to the terminal device 140, for example, in terms of authentication, authorization, and encryption. Next, the terminal device 140 enters into an idle mode at step 620. When the terminal device 140 is to transmit data, the terminal device 140 directly performs UL data transmission on the UL broadcast channel.

As described above, the UL broadcast channel may be configured in any suitable way. For example, specific time and frequency resources and channel scrambling codes of the UL broadcast channel may be pre-configured during the network deployment phase. Alternatively, the time and frequency resources as well as the channel scrambling codes may be dynamically configured for the broadcast channel by the network node when necessary, and then information for indicating the configured UL broadcast channel is informed to other network nodes and the terminal device in the network.

In this example, because the coverage areas 110′ and 120′ of the network nodes 110 and 120 can both cover the terminal device 140, the network nodes 110 and 120 can both receive data broadcast by the terminal device 140. The data broadcast by the terminal device 140 has no conflicts at the network nodes 110 and 120. Accordingly, both of the network nodes 110 and 120 may correctly perform decoding, demodulation, and the like on the data. Then, the network node 120 sends an acknowledgement (ACK) response to the terminal device 140 in timeslot 1 at step 640, so does the network node 110 in timeslot 2 at step 650.

If the terminal device 140 has a large amount of data to be transmitted, many UL resources need to be occupied. If the UL transmission has conflicts at the network nodes, many of the resources will be wasted. In order to reduce such a waste of the resources, in one embodiment, as shown in FIG. 6, the terminal device 140 does not directly transmit the data per se on the UL broadcast channel at step 630, but sends a data transmission request. Accordingly, the ACK responses sent by the network nodes 110 and 120 to the terminal device 140 at steps 640 and 650 include the UL grants for the subsequent data transmission. In addition, the ACK responses may also include the TA, the C-RNTIs, and the like.

In addition to sending the data request instead of transmitting the data, in another embodiment, when the amount of data to be transmitted by the terminal device 140 is very large, the terminal device 140 may divide the data into several parts of data which may be transmitted in many transmission opportunities. In this example, as shown in FIG. 6, in the initial UL data transmission at step 630, the terminal device 140 may include an indicator of a subsequent packet in the transmitted data so as to indicate to the network node that there is a subsequent packet to be transmitted. Likewise, after the network nodes 110 and 120 correctly receive the initial UL data, the ACK responses sent to the terminal device 140 may include the UL grants for the subsequent packet.

After receiving the grants from the network nodes 110 and 120, the terminal device 140 may select a network node to which the subsequent data is to be transmitted. As described above, the terminal device 140 may perform the selection based on any suitable factor. For example, the terminal device 140 may select a network node for subsequent communication according to the signal qualities of the network nodes, whether of establishing connections with the network nodes, other suitable factors, or any combination of the above factors.

In this example, the terminal device 140 selects the network node 120 for the subsequent communication with which the connection has already been established. Then, at step 660, the terminal device 140 sends a subsequent UL packet to the network node 120, and the subsequent UL packet carries an indicator of an subsequent packet because there is still a subsequent packet to be transmitted. The terminal device 140 sends a UL transmission terminate message to the network node 110 at step 670 to inform the network node 120 of the subsequent transmission termination. As described above, the UL transmission terminate message may be pre-configured by the system and implemented in any suitable form. For example, the UL transmission terminate message may be implemented in the RRC signaling.

Next, the terminal device 140 continues to transmit data to the network node 120 at step 680. In this example, then the terminal device has no data to be transmitted, and, therefore, the indicator of the subsequent packet is not carried at step 680. Then, the terminal device 140 completes the data transmission at step 690 and returns to an idle state.

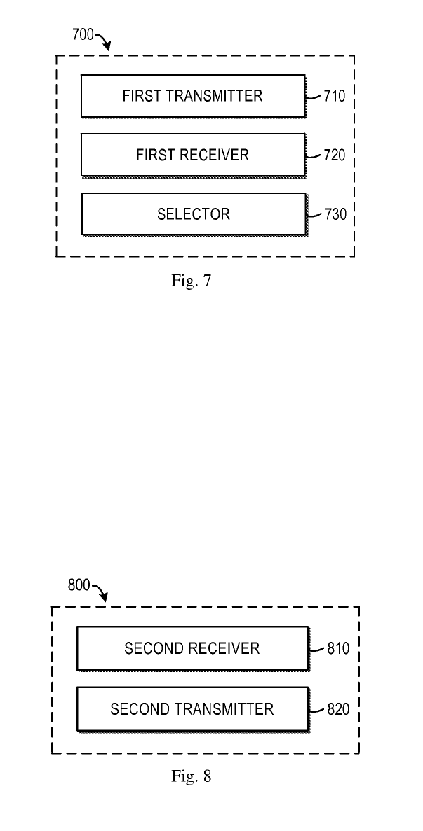

FIG. 7 illustrates a block diagram of a terminal device 700 according to one embodiment of the present disclosure. It is to be understood that the terminal device 700 may be implemented as the terminal device 140 or 150 in the communication network 100 shown in FIG. 1.

As shown, the terminal device 700 comprises a first transmitter 710 and a first receiver 720. The first transmitter 710 is configured to initiate uplink broadcast on an uplink channel. The first receiver 720 is configured to receive, from at least one network node, a response to the uplink broadcast. In one embodiment, the uplink channel may be shared by a plurality of terminal devices based on contention.

In one embodiment, an identifier of a network node may be excluded from the uplink broadcast. In one embodiment, the uplink channel may include a random access channel. Accordingly, the first transmitter 710 may be further configured to: send, on the random access channel, a random access request without scrambling using the identifier of the network node.

In one embodiment, an indication of subsequent uplink transmission may be included in the uplink broadcast. In this example, the first receiver 720 may be further configured to receive the responses from a plurality of network nodes, the responses including grants for the subsequent uplink transmission.

In one embodiment, the terminal device 700 may further comprise a selector 730. The selector 730 is configured to, in response to receiving the grants from the plurality of network nodes, select a network node to communicate from the plurality of network nodes. In this example, the first transmitter 710 may be further configured to perform the uplink transmission to the selected network node. In one embodiment, the first transmitter 710 may be further configured to send a UL transmission terminate message to an unselected network node of the network nodes.

FIG. 8 shows a block diagram of a network node 800 according to one embodiment of the present disclosure. It is to be understood that the network node 800 may be implemented as the network node 110, 120 or 130 in the communication network 100 shown in FIG. 1.

As shown, the network node 800 comprises a second receiver 810 and a second transmitter 820. The second receiver 810 is configured to receive uplink broadcast from a terminal device on an uplink channel. The second transmitter 820 is configured to, in response to the reception of the uplink broadcast, send to the terminal device a response to the uplink broadcast. In one embodiment, the uplink channel may be shared by the terminal device and a further terminal device based on contention.

In one embodiment, an identifier of a network node may be excluded from the uplink broadcast. In one embodiment, the uplink channel may include a random access channel. Accordingly, the second receiver 810 may be further configured to: receive a random access request from the terminal device on the random access channel, the random access request being sent without being scrambled using the identifier of the network node.

In one embodiment, an indication of subsequent uplink transmission may be included in the uplink broadcast. In this example, the response sent to the terminal device may include a grant for the subsequent uplink transmission. In one embodiment, the second receiver 820 may be further configured to: receive a UL transmission terminate message from the terminal device.

It is to be understood that each element/unit in the terminal device 700 and network node 800 corresponds to each step in the methods 200-600 as described with reference to FIGS. 2-6. Therefore, the operations and features described above with reference to FIGS. 2-6 are likewise applicable to the terminal device 700 and network node 800 as well as the units comprised therein, and have the same effect. Specific details will be omitted.

The elements/units included in the terminal device 700 and the network node 800 may be implemented in various manners, including software, hardware, firmware or any combination thereof. In one embodiment, one or more elements may be implemented using software and/or firmware, for example, machine-executable instructions stored on a storage medium. In addition to or instead of the machine-executable instructions, parts or all of the units in the terminal device 700 and the network node 800 may be implemented at least in part by one or more hardware logic components. For example, and without limitation, illustrative types of hardware logic components that can be used include Field-Programmable Gate Arrays (FPGAs), Application-Specific Integrated Circuits

(ASICs), Application-Specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the present disclosure can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or functional actions, it is to be understood that the present disclosure defined in the appended claims is not necessarily limited to the specific features or actions described above. Rather, the specific features and acts described above are disclosed as example forms of implementing the claims.

1. A method of uplink broadcast, comprising:
initiating the uplink broadcast on an uplink channel; and
receiving, from at least one network node, a response to the uplink broadcast.

2. (canceled)

3. The method according to claim 1, wherein an identifier of a network node is excluded from the uplink broadcast.

4. The method according to claim 3, wherein the uplink channel includes a random access channel, and wherein initiating the uplink broadcast on the uplink channel comprises:
sending, on the random access channel, a random access request without scrambling using the identifier of the network node.

5. The method according to claim 1, wherein an indication of subsequent uplink transmission is included in the uplink broadcast,
wherein receiving the response from the at least one network node comprises: receiving responses from a plurality of network nodes, the responses including grants for the subsequent uplink transmission; and
wherein the method further comprises:
in response to receiving the grants from the plurality of network nodes, selecting a network node to communicate from the plurality of network nodes, and
performing the subsequent uplink transmission to the selected network node.

6. (canceled)

7. A method of uplink broadcast, comprising:
receiving the uplink broadcast from a terminal device on an uplink channel; and
in response to the reception of the uplink broadcast, sending, to the terminal device, a response to the uplink broadcast.

8. (canceled)

9. The method according to claim 7, wherein an identifier of a network node is excluded from the uplink broadcast.

10. The method according to claim 9, wherein the uplink channel includes a random access channel, and wherein receiving the uplink broadcast from the terminal device on the uplink channel comprises:
receiving a random access request from the terminal device on the random access channel, the random access request being sent without being scrambled using the identifier of the network node.

11. The method according to claim 7, wherein an indication of subsequent uplink transmission is included in the uplink broadcast, and
wherein the response sent to the terminal device includes a grant for the subsequent uplink transmission.

12. (canceled)

13. A terminal device, comprising:
a first transmitter configured to initiate uplink broadcast on an uplink channel;
a first receiver configured to receive, from at least one network node, a response to the uplink broadcast.

14. (canceled)

15. The terminal device according to claim 13, wherein an identifier of a network node is excluded from the uplink broadcast.

16. The terminal device according to claim 15, wherein the uplink channel includes a random access channel, and wherein the first transmitter is configured to: send, on the random access channel, a random access request without scrambling using the identifier of the network node.

17. The terminal device according to claim 13, wherein an indication of subsequent uplink transmission is included in the uplink broadcast,
wherein the first receiver is configured to receive responses from a plurality of network nodes, the responses including grants for the subsequent uplink transmission,
wherein the terminal device further comprises:
a selector configured to, in response to receiving the grants from the plurality of network nodes, select a network node to communicate from the plurality of network nodes, and
wherein the first transmitter is configured to perform the subsequent uplink transmission to the selected network node.

18. (canceled)

19. A network node, comprising:
a second receiver configured to receive an uplink broadcast from a terminal device on an uplink channel; and
a second transmitter configured to, in response to the reception of the uplink broadcast, send, to the terminal device, a response to the uplink broadcast.

20. (canceled)

21. The network node according to claim 19, wherein an identifier of a network node is excluded from the uplink broadcast.

22. The network node according to claim 21, wherein the uplink channel includes a random access channel, and wherein the second receiver is configured to: receive a random access request from the terminal device on the random access channel, the random access request being sent without being scrambled using the identifier of the network node.

23. (canceled)

24. (canceled)
